(19) United States
(12) Patent Application Publication
(10) Pub. No.: US 2020/0038924 A1
(43) Pub. Date: Feb. 6, 2020

(54) METHOD FOR PRODUCING A BINDER FOR THE CONDITIONING OF SLUDGES, SOILS CONTAINING WATER AND FOR THE NEUTRALIZATION OF ACIDS

(71) Applicants: Claus Gronholz, Ahausen/Eversen (DE); TARTECH ECO INDUSTRIES AG, Berlin (DE)

(72) Inventor: Claus Gronholz, Ahausen/Eversen (DE)

(21) Appl. No.: 16/481,455

(22) PCT Filed: Jan. 24, 2018
(86) PCT No.: PCT/EP2018/051693

§ 371 Date: Oct. 9, 2019

(30) Foreign Application Priority Data
Jan. 27, 2017 (DE) 10 2017 101 628.7

(51) Int. Cl. B09B 3/00; C02F 11/00; C04B 7/28; C04B 7/40; C04B 18/04; C04B 28/08; B03B 9/04

(52) U.S. Cl. CPC B09B 3/0041; C02F 11/008; C04B 7/28; C04B 2111/00784; C04B 18/0418; C04B 28/08; B03B 9/04; C04B 7/40

(57) ABSTRACT

The invention relates to a method for producing a binder from slag for conditioning sludges/dredged material, soils containing water and for the neutralization of acids. According to the invention, the slag from a waste incinerator is crushed, then metal is removed and the crushed slag is graded into a fraction greater than 2.0-3.0 mm and a fraction smaller than 2.0-3.0 mm, the fraction 0/2.0-0/3.0 mm is dried in a dryer to a terminal humidity less than 1.5 wt. %-2.5 wt. %, as a result of which the pozzolanic properties of the slag are reactivated, the yield from the dryer is further crushed in a high-speed impact mill to a stable cubic grain structure and the metal released in this process is removed, and the 0/500-0/750 μm fraction forming the binder is separated from this crushed slag.

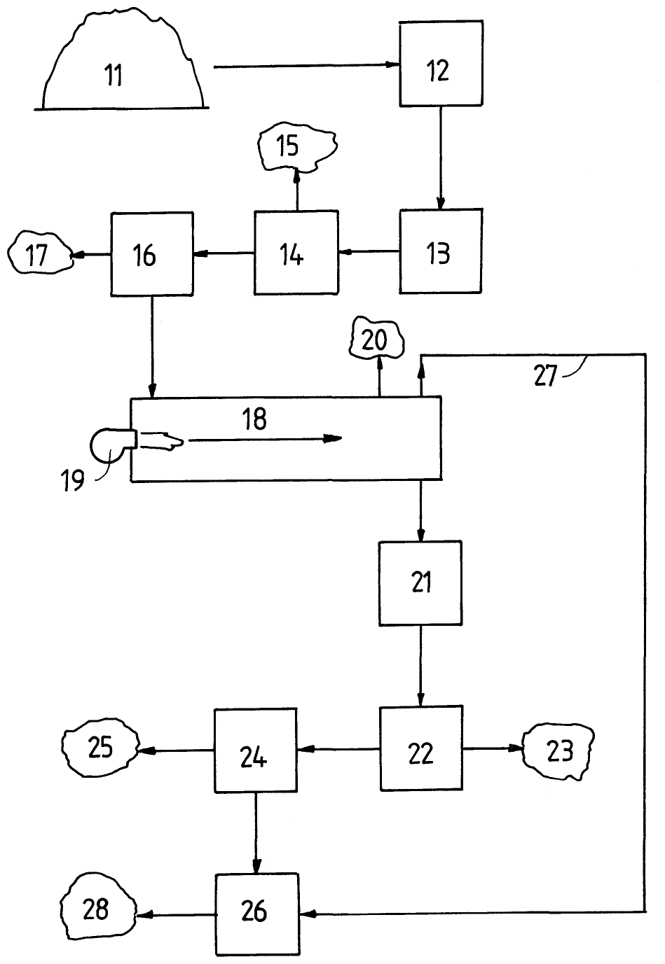

The invention relates to a method for producing a binder of slag from waste incineration plants for the conditioning of sludges, such as dredged material/dredging sludge, soils containing water and for the neutralization of acids. In particular, the invention relates to the production of a slag binder from municipal waste incineration plants, known as MWIP slag. In principle, however, the invention may also relate to slags from other thermal waste processing. Slag is discussed in the following, without any restriction being attached thereto. Conditioning is understood to mean a treatment which alters or maintains the properties of the slag.

It is customary to dredge certain waters, especially in port areas or harbor inflows, in order to make them passable for larger vessels with a larger draft. The dredged material must be dumped, as it is often contaminated and currently not available for further use. The dredged material is wet after dredging and the escaping water must also be collected because it must not get into the groundwater.

Furthermore, the dredged material is of low strength, so that even in the solid state it can only be deposited with a low slope angle. Due to the constantly leaking water, it is also necessary to provide drainage layers of sand between the dredged layers, which sand layers are also offset with drainage pipes to allow the water to escape. It is known that a layer of dredged material on the landfill site can only be about 600 to 800 mm high. In between, there must be a drainage layer approximately 200 to 300 mm thick. Therefore, relatively complex and large-scale landfill sites are required, especially since the water leaks over a very long time.

The dumping of dredged material is a problem, for example, for the city of Hamburg, as the port of Hamburg and the Elbe must be dredged continuously so that deep-draft ships are able to reach the moorings in the port. This dredged material is also contaminated. However, the city of Hamburg has only limited land available, so that the large-scale landfill of the dredged material is not readily possible. Due to the additional drainage layers, however, a large part of the landfill volume is required for inert sand. Overall, therefore, a relatively large area must be provided for dumping a relatively small amount of dredged material, and such an area is available in the city-state of Hamburg only to a limited extent.

The object of the invention is to provide an inexpensive binder for the conditioning of the dredged material through which the dredged material is solidified and thus allows a larger slope angle.

According to the invention, the slag from a waste incineration plant is crushed, the crushed slag is graded into a fraction greater than 2.0 or 3.0 mm and a fraction smaller than 2.0 or 3.0 mm, the separated smaller fraction 0/2.0 or 0/3.0 mm is dried in a dryer to a terminal humidity content of less than 1.5 wt. %-2.5 wt. %, as a result of which the pozzolanic properties of the slag are maintained, the yield from the dryer is further crushed in a high-speed impact mill to a stable cubic grain structure, and the 0/500 to 0/750 μm fraction forming the binder is separated from this crushed slag. It has been shown that slag from municipal waste incineration plants (MWIP) include inter alia CaO (calcium oxide, quicklime), Al₂O₃+Fe₂O₃ (aluminum oxide+iron(III) oxide) and SiO₂ (silicon dioxide, quartz) as ingredients having a composition corresponding to that of cement. It has been found that by drying, these pozzolanic properties of the slag can be maintained or reactivated and are thus reusable. The slag therefore has pozzolanic properties after drying, which can be used for setting/conditioning the dredged material. Thus, two waste materials can be deposited easily and inexpensively, since both the dredged material and the slag from a municipal waste incineration plant are available in sufficient quantities spatially close to each other, for example, in Hamburg.

The above-mentioned fractional limits 0/2.0 mm or 0/3.0 mm are regarded as limit values for the grain boundary, which is defined by the screen used. The specified range thus also includes the intermediate values for the grain boundary, for example the fraction 0/2.5 mm.

It is expedient if the slag is stored for about 2.5 to 3.5 months before the first crushing/processing. This process, known as calcination, is generally required by law for the reuse of slag.

It is particularly expedient if the metal-containing substances are removed during the treatment process of the slag before drying. As a result, recyclable metals are recovered from the slag otherwise deposited on the landfill, as a result of which the production process of the binder is also economically favorable.

Furthermore, it is favorable if the drying of the separated smaller fraction 0/2.0 or 0/3.0 mm takes place in a drum dryer. The drying is preferably carried out by the co-current method. It has been found that this co-current drying allows the pozzolanic properties to be maintained uniformly and well. It is provided that drying is carried out at a temperature in the drum of 270° C. to 330° C. In particular, it is provided that the temperature in the drum outside the burner zone does not exceed 300° C. in order to facilitate the process for maintaining the pozzolanic properties of the crushed slag.

In a further embodiment of the invention, the metal-containing substances are at least partially further removed from the separated fraction 0/2.0 or 0/3.0 mm after drying. Thus, the yield from the slag can be further increased by recovered metals, so that the production costs of the binder can be further reduced.

The slag is present downstream of the dryer in the form of irregularly fissured particles. It is expedient if after drying the crushing is carried out in a high-speed impact mill. As a result, the unstable sintered conglomerates are crushed into compact cube-shaped particles. From this mixture, the fraction 0/500 or 0/750 μm is separated as a binder. This can be done with conventional grading methods. The compact cube-shaped particles produced by the high-speed impact mill are very miscible, so that the binder can be mixed with the dredged material using simple mixing devices.

Drying inevitably produces filter dusts, which are collected by known filter devices. The filter dusts have the same chemical composition as the slag. It is therefore provided that the filter dust from the drying is supplied to the binder. In any case, the binder comprises the fraction 0/500 or 0/750 μm, which also matches the filter dust obtained, the particles of which are generally smaller than 50 μm. The fraction <500 or <750 μm of the slag can therefore be used completely as a binder.

The invention also relates to a binder which consists of a fraction <500 μm to <750 μm of a slag from waste incineration plants, which has been treated by the method described at the outset. The binder is made from a waste product and is thus inexpensive and available in large quantities.

Furthermore, the invention relates to a landfillable substance mixture consisting of a wet, solid dredged material to which the binder produced by the method described above has been added and mixed or conditioned therewith. ‘Solid’ is understood to be a state in which the dredged material can be cut and still transported with a shovel. It is provided that the binder content is between 10 wt. % and 40 wt. % and in particular between 20 wt. % and 30 wt. %. The binder can be produced inexpensively from a waste product, the slag from waste incineration plants. Together with the wet dredged material, a landfillable mixture of sufficient strength is created which allows landfilling with a relatively steep slope angle. Furthermore, it has been shown that the swelling behavior of the substance mixture is low, so that the volume remains relatively constant. Landfilling is thus easier.

Due to the achievable steeper slope angle, significantly more dredged material can be deposited in an area. Furthermore, the water in the dredged material is bound by the binder, which penetrates due to the size and cubic shape thereof to the capillary cavities, so that said water does not escape. It is therefore no longer necessary to provide drainage layers with drainage pipes between individual landfill layers. This can significantly reduce landfill costs. Furthermore, catching the water from the dredged material conditioned in this way is no longer necessary, because it is bound.

Furthermore, after 7 days, the mixture of dredged material and the binder already has a significantly lower water content than the dredged material without binder. The water content has dropped even further after 28 days. The measured values are shown in the following table:

Water content in wt. %

| | Dredged | +10 wt. % | +20 wt. % | +30 wt. % |
|---|---|---|---|---|
| Time | material | binder | binder | binder |
| 0 days | 86.3 | 68.9 | 58.9 | 53.8 |
| 7 days | 84.8 | 63.8 | 54.8 | 50.1 |
| 28 days | 83.7 | 58.4 | 50.5 | 46.0 |

By adding the binder, the compressive strength of the deposited dredged material could be significantly increased, as shown in the following table:

Compressive strength in kN/m²

| | Dredged | +10 wt. % | +20 wt. % | +30 wt. % |
|---|---|---|---|---|
| Time | material | binder | binder | binder |
| 7 days | 17.7 | 30.2 | 53.6 | 64.5 |
| 28 days | 28.6 | 49.4 | 87.9 | 103.9 |

Furthermore, the vane shear strength of the deposited substance mixture of dredged material and binder, which is decisive for the slope angle, is increased as shown in the following table:

Vane shear strength in kN/mm²

| | Dredged | +10 wt. % | +20 wt. % | +30 wt. % |
|---|---|---|---|---|
| Time | material | binder | binder | binder |
| 7 days | 10.5 | 23.5 | 39.0 | 68.0 |
| 28 days | 22.0 | 35.0 | 64.0 | 91.0 |

The tables with the measured values show that after 28 days, the substance mixture to be landfilled has a high compressive strength and a high vane shear strength, which are sufficient to fill up a landfill with a steeper slope angle. Due to the lower water content, the provision of additional drainage layers is no longer necessary, since this water is already bound during conditioning and does not escape. Therefore, significantly more dredged material can be deposited in a smaller area. The production costs of the binder are compensated by the cost savings in landfilling and by the recyclables recovered from the slag.

The binder is also suitable for the conditioning and solidification of industrial sludges, such what is known as red mud from primary aluminum production.

After conditioning the red mud with the binder, this substance mixture can also be landfilled more efficiently. Drilling mud from oil production can also be conditioned with the binder and thus made landfillable.

Another use of the binder is to use it as a neutralizing agent for acidic waste from the chemical industry due to the high pH of 10.0-11.5 and its fine grain structure and its low residual moisture. The high ph value results from the formation-related contents of the slag and from the washing of the slag with lime (Ca(OH)₂), which possesses basic properties. This also gives the slag its moisture content.

The invention will be explained in more detail below with reference to the schematic drawing. The sole figure shows a method scheme according to the invention.

The slag 11 originating from a waste incineration plant is first stored in an interim storage facility 12 for a predetermined time of 2.5 to 3.5 months. Subsequently, the slag is crushed in a first crushing device, for example in an impact mill 13. Metallic components are separated from the crushed slag in a separation device 14 known per se. Ferrous metals can be separated using magnetic separators. These metals 15 are sent for further use.

The slag thus cleaned of metals passes into a first grading station 16, in which the slag is graded into a fraction greater than 3.0 mm and a fraction less than 3.0 mm. The fraction 17 greater than 3.0 mm is discharged for another use.

The fraction smaller than 3.0 mm is fed to a drum dryer 18, in which the slag is dried by the co-current method to a residual moisture content of <1.5 wt. % to <2.0 wt. %. The temperature at the burner 19 is about 600° C., while the temperature in the drum is about 300° C. The drying process at these temperatures reactivates the pozzolanic properties of the slag. The water vapor 20 produced during drying is drawn off with a filter system (not shown).

The solid discharge of the drying is further crushed in a second crushing device 21. This can be done, for example, in a high-speed impact mill where the fissured unstable sintered conglomerates are crushed to form stable cube-shaped particles. Also, a blasting of the particles can take place with release of the metals contained therein.

The slag crushed in this way is fed to a further metal separation apparatus 22. Here, the non-ferrous metals and the ferrous metals 23 are removed from the slag and sent for further use.

The remaining slag is then separated in a second grading apparatus 24 into a fraction greater than 750 μm and a fraction smaller than 750 82 m. The fraction 25 greater than 750 μm is discharged for another use.

The fraction 0/750 μm has the desired pozzolanic properties and grain structures. This fraction is mixed in a mixing device 26 with the filter dust 27 from the filter unit of the drying device 18. This mixture forms the binder 28.

The binder 28 can be mixed with dredged material in a mixing plant and then transported to a landfill site. There, the substance mixture made of dredged material and binder hardens. Due to the setting, there is no longer the risk that water will escape or that environmentally-polluting substances will be washed out.

1. A method for producing a binder from slags from municipal waste incineration plants (MWIP slags) for the conditioning of sludges, soils containing water and for the neutralization of acids, wherein the slag (11) from a waste incineration plant is crushed, the crushed slag is graded into a fraction greater than 2.0 to 3.0 mm and a fraction smaller 2.0 to 3.0 mm, the separated smaller fraction 0/2.0 or 0/3.0 mm is dried in a dryer (18) to a terminal humidity of less than 1.5 wt. %-2.5 wt. %, as a result of which the pozzolanic properties of the slag are maintained, the yield of the dryer is further crushed, and the 0/500 μm to 0/750 μm fraction forming the binder (28) is separated from this crushed slag.

2. The method according to claim 1, wherein the slag is stored for about 2.5 to 3.5 months before the first crushing.

3. The method according to claim 1, wherein before drying, the metal-containing substances are at least partially removed by digestion from the crushed slag.

4. The method according to claim 1, wherein the drying of the separated smaller fraction 0/2.0 mm to 0/3.0 mm is performed in a drum dryer (18).

5. The method according to claim 4, wherein the drying is carried out by the direct co-method.

6. The method according to claim 4, wherein the drying is carried out at a temperature in the drum of 270° C. to 330° C.

7. The method according to claim 1, wherein after drying, the metal-containing substances are at least partially removed by digestion from the smaller fraction 0/2.0 to 0/3.0 mm

8. The method according to claim 1, wherein after drying, crushing to a stable cubic grain structure is carried out with a high-speed impact crusher or a high-speed impact mill (21).

9. The method according to claim 1, wherein the filter dust from the drying is supplied to the binder.

10. A binder consisting of a fraction smaller than 500-750 μm of slag from waste incineration plants which has been treated by the method according to claim 1.

11. A landfillable substance mixture consisting of a wet, solid sludge/dredged material to which the binder produced by the method according to claim 1 has been added and mixed/conditioned therewith.

12. The landfillable substance mixture according to claim 11, wherein the binder content is between 10 wt. % and 40 wt. %.

13. Use of the binder prepared by the method according to claim 1 for the neutralization of acidic wastes.
